(19) United States
(12) Patent Application Publication
(10) Pub. No.: US 2025/0142602 A1
(43) Pub. Date: May 1, 2025

(54) METHOD AND APPARATUS FOR BROADCAST REMOTE ID TRANSMISSIONS OF UAVS

(71) Applicant: LENOVO (BEIJING) LIMITED, Beijing (CN)

(72) Inventors: Jing HAN, Beijing (CN); Min XU, Beijing (CN); Haiming WANG, Beijing (CN); Lianhai WU, Beijing (CN); Ran YUE, Beijing (CN); Jie HU, Beijing (CN)

(21) Appl. No.: 18/730,580

(22) PCT Filed: Jan. 21, 2022
(86) PCT No.: PCT/CN2022/073225

§ 371 Date: Jul. 19, 2024

(51) Int. Cl. H04W 72/40; H04W 72/51

(52) U.S. Cl. CPC H04W 72/40; H04W 72/51

(57) ABSTRACT

Embodiments of the present application are directed to a method and apparatus for broadcast remote ID transmissions of an unmanned aerial vehicle (UAV). In an embodiment of the present application, a first user equipment comprise: a receiver; a processor coupled to the receiver; and a transmitter coupled to the receiver and the processor. The receiver is configured to receive a first system information block (SIB) from a first cell. The processor is configured to determine a first resource pool for transmitting a broadcast remote identification based on the first SIB. The transmitter is configured to transmit the broadcast remote identification with the first resource pool.

### TECHNICAL FIELD

Embodiments of the present application generally relate to wireless communication technology, especially to a method and apparatus for a broadcast remote ID for an unmanned aerial vehicle (UAV).

### BACKGROUND

The remote ID is of a UAV is required due to regulations of the national government e.g. Federal Aviation Administration (FAA), and all drone pilots are required to register their Unmanned Aircraft System (UAS) so as to operate their aircraft in accordance with the final rule on the remote ID beginning Sep. 16, 2023.

### SUMMARY OF THE APPLICATION

Embodiments of the present application provide methods and apparatuses for broadcast remote ID transmissions of a UAV.

An embodiment of the present application provides a first user equipment comprising: a receiver; a processor coupled to the receiver; and a transmitter coupled to the receiver and the processor. The receiver is configured to receive a first system information block (SIB) from a first cell. The processor is configured to determine a first resource pool for transmitting a broadcast remote identification based on the first SIB. The transmitter is configured to transmit the broadcast remote identification with the first resource pool.

Another embodiment of the present application provides a first base station comprising: a processor and a transmitter coupled to the processor. The transmitter is configured to transmit a first system information block (SIB). The first SIB indicates a first resource pool for transmitting a broadcast remote identification.

A further embodiment of the present application provides a method performed by a first user equipment (UE). The method comprises: receiving a first system information block (SIB) from a first cell; determining that a first resource pool for transmitting a broadcast remote identification based on the first SIB; and transmitting the broadcast remote identification with the first resource pool.

A further embodiment of the present application provides a method performed by a first base station (BS). The method comprises: determining a first resource pool dedicated to transmitting a broadcast remote identification; and transmitting a first system information block (SIB) indicating the first resource pool for transmitting the broadcast remote identification.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application;

FIG. 2 illustrates a wireless communication system according to some embodiments of the present application;

FIG. 3 illustrates a wireless communication system according to some embodiments of the present application;

FIG. 4 illustrates a wireless communication system according to some embodiments of the present application;

FIG. 5 illustrates a schematic diagram of procedures for transmitting a broadcast remote ID according to some embodiments of the present application;

FIG. 6 illustrates a flow chart of a method for transmitting a broadcast remote ID according to some embodiments of the present application;

FIG. 7 illustrates a flow chart of another method for a broadcast remote ID according to an embodiment of the present application; and

FIG. 8 illustrates a block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings.

The remote ID is the ability of a drone in flight to provide identification and location information that can be received by other parties. Remote ID helps the FAA, law enforcement, and other federal agencies to find the corresponding control station when a drone appears flies in an unsafe manner or in an area which is not allowed to fly. The remote ID also lays the foundation of the safety and security groundwork needed for more complex drone operations. The remote ID of a UAV may include the broadcast remote ID, the networked remote ID, and the non-equipped remote ID. The content of a remote ID may include, for example, the drone ID, the drone's location, the drone's altitude, the drone's velocity, the control station's location, the control station's elevation, the time mark, the emergency status, and etc. The present application is applicable for the broadcast remote ID is supportable in a 3GPP system. To support the broadcast remote ID in a 3GPP system, one suitable method is using the PC5 interface, or in another word, the sidelink transmission, e.g., described in System Aspects Work Group (SA2) Study Item Description (SID).

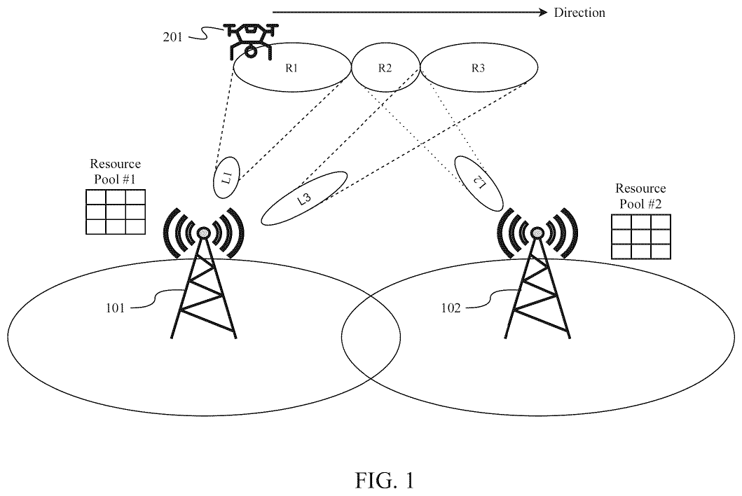

FIG. 1 illustrates a wireless communication system according to some embodiments of the present application. FIG. 1 includes base stations (BSs) (or cells) 101 and 102 and a UAV 201. The BS 101 transmits lobes L1 and L3 through its antenna. The lobes L1 and L3 may be the side lobes transmitted by the BS 101. The BS 102 transmits lobe L2 through its antenna. The devices in regions R1 and R3 are served by the BS 101 through the lobes L1 and L3. The devices in regions R2 are served by the BS 102 through the lobe L2. The BS 101 configures resource pool #1 for a given type of transmission. The BS 102 configures resource pool #2 for a given type of transmission.

When the UAV 201 flies in the direction indicated by the arrow shown in FIG. 1, the UAV would travel from the regions R1, R2, and R3. The regions R1 and R3 are served by the BS 101, and the regions R2 is served by the BS 102. The UAV 201 would experience frequent serving BS changes (or serving cell changes) during the flight route. The serving BS changes (or serving cell changes) may be more frequent if the UAV 201 is served by a side lobe of a BS (or a cell).

Because of the frequent serving BS changes (or serving cell changes), the UAV (i.e., the UE) has to change the resource pool frequently. Taking FIG. 1 as an example, when the UAV 201 is in the regions R1 and R3, the UAV 201 may use the resource pool #1 of the BS 101. When the UAV 201 is in the region R2, the UAV 201 may use the resource pool #2 of the BS 102. When the UAV 201 travels from the region R1 to the region R2, the resource pool used by the UAV 201 changes from the resource pool #1 to the resource pool #2. When the UAV 201 travels from the region R2 to the region R3, the resource pool used by the UAV 201 changes from the resource pool #2 to the resource pool #1. Furthermore, the UAV (i.e., the UE) may always use exceptional pool which is based on random selection during cell reselection and before sensing results available.

A system information (SI) area can be used to provide for a given validity area where the UE (user equipment) does not need to acquire a new pool of resources while moving within the validity area. The validity area may be a complete area. The validity area may include the coverage of one or more BSs. The validity area may include one or more cells. The validity area may be a complete area including a plurality of portions of a plurality of cells.

For broadcast remote ID transmissions or UAV sidelink transmissions, because a UAV flying in the air could detect much more cells (or BSs) with respect to a terrestrial UE (e.g., due to no barriers in the line-of-sight), the area of resource pool used for broadcast remote ID transmissions or UAV sidelink transmissions may be different from that used for sidelink transmissions of terrestrial UEs.

The present application provides an area-based resource pool for broadcast remote ID (BRID) transmissions or UAV PC5 transmissions. The present application further provides a separate configuration of the area-based BRID resource pool specifically used for UAV BRID transmissions. The present application further introduces a new area-based SI specifically used for UAV BRID transmissions. The present application further provides an area-based BRID resource pool, which is only take effect when the UAV flies above a given height (or a given elevation).

The present application provides a height-based resource pool for BRID transmissions or UAV PC5 transmissions.

The present application provides that, during a handover (HO), whether a dedicate resource pool can be reused is indicated in the HO command.

The present application provides new conditions for UAV to enter Radio Resource Control (RRC) CONNECTED mode, which may be based on the BRID resource pool configuration and the UAV's flight height.

For new radio (NR) sidelink communications, the resource pool(s) can be provided for a given validity area where the UE does not need to acquire a new pool of resources while moving within the validity area, at least when this pool is provided by system information block (SIB). The NR SIB area scope mechanism (e.g., as specified in TS 38.331) may be reused to enable validity area for sideling resource pool configured via broadcasted system information.

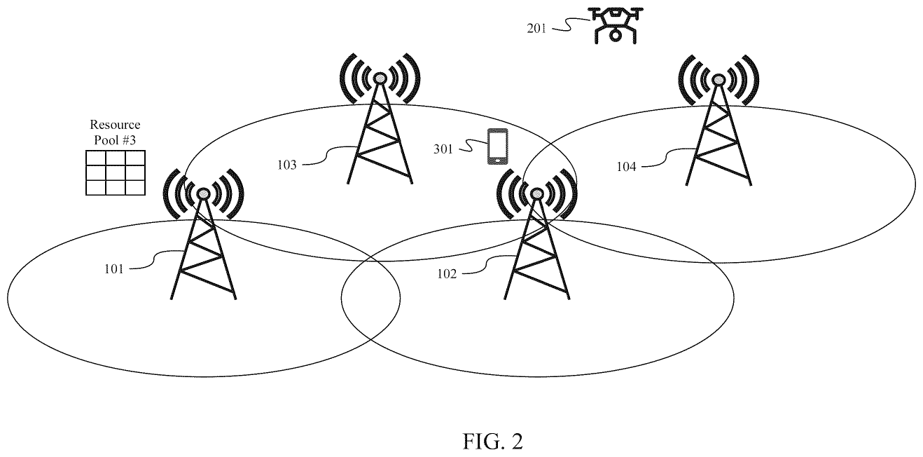

FIG. 2 illustrates a wireless communication system according to some embodiments of the present application. FIG. 1 includes BSs (or cells) 101 to 104, a UAV 201, and a UE 301.

In one embodiment, the UAV 201 is authorized and configured to broadcast remote ID periodically. The UAV 201 is capable of using sidelink transmissions in a Long Term Evolution (LTE) system and/or a NR system. The UAV 201 may be in the coverage of a LTE or NR network.

To avoid the UAV 201 frequently changing the resource pool because of serving cell changes, a LTE or NR network configures a resource pool specifically used for UAVBRID transmissions and is valid in an area instead of only valid in specific cell. In FIG. 2, resource pool #3 is configured for UAV BRID transmissions in the area consisting of BSs (or cells) 101 to 104. The UAV 201 transmits the BRID with the resource pool #3. The UE 301 (e.g., a device of the FAA or other federal agencies) can receive the BRID of the UAV 201 with the resource pool #3. The validity area of BRID resource pool could be different from that of the resource pools configured in a SIB for terrestrial sidelink UEs. For example, the resource pools configured in a SIB for terrestrial sidelink UEs include: the LTE sidelink communication pool, the LTE sidelink discovery pool, the LTE V2X sidelink communication pool, the NR sidelink communication pool, the NR sidelink discovery pool, and etc. The UAV 201, from the network, acquires BRID specific resource pool configuration for broadcast remote ID transmission, when the UAV 201 is in coverage of a given area.

In a further embodiment, the BRID resource pool (e.g., resource pool #3) is configured associated with an area. For example, a mapping between a BRID resource pool and an area ID is configured. This type of configuration can be included in a SIB for sidelink configuration. During the serving cell (or the serving BS) changes due to mobility, when the UAV 201 reselects another cell, the UAV 201 acquires the BRID resource pool configuration from system information of sidelink configuration. The UAV 201 determines whether the BRID resource pool is changed according to the associated area ID. For example, the UAV 201 checks whether the area ID received in the configuration (i.e., in the SIB) is identical to or different from the corresponding area ID of the current used resource pool. If the received area ID is identical to the corresponding area ID of the current used resource pool, the UAV 201 would not update or change the resource pool and would continue to use the current resource pool. If the received area ID is different from the corresponding area ID of the current used resource pool, the UAV 201 would update or change the resource pool to a new resource pool specified in configuration and would use an exceptional resource pool before the sensing results is available for the new resource pool.

In an embodiment, the BRID resource pool configuration is included in a new SIB which is different from the SIB for sidelink configuration of terrestrial UEs. This new SIB can be associated with a SI area ID and can be configured in e.g. SIB1. The UAV 201 configured to transmit the broadcast remote ID would acquire this new SIB when select, reselect, or handover to a new cell (or a new area).

In an embodiment, the area-based BRID resource pool can be used only when UAV flies above a height threshold (or an elevation threshold). The height threshold (or the elevation threshold) can be configured by the network. For example, the network configures BRID resource pools which are associated with an area ID associated with a height threshold. For example, when the UAV 201 transmits a broadcast remote ID, the UAV 201 only uses the configured area-based BRID resource pool (e.g., resource pool #3) if the UAV 201 determines its height being above the height threshold. When the UAV 201 transmits a broadcast remote ID, the UAV 201 only uses the configured area-based BRID resource pool (e.g., resource pool #3) if the UAV 201 determines its height being in a predetermined range. If the UAV 201 determines its height not being above the height threshold or in a certain range, the UAV 201 uses a BRID resource pool that is not associated with area. If the UAV 201 determines its height not being above the height threshold or in a certain range, the UAV 201 uses the resource pool for normal sidelink communication/discovery. In another word, during a resource pool selection procedure, the UAV 201 determines whether the flying height is above the configured (or predetermined) threshold and selects the corresponding area-based resource pool.

In some embodiments, the area-based BRID resource pool (e.g., resource pool #3) can be used or selected only when the number of cells detected by the UAV 201 is greater than a given number threshold. For example, the network configures a number threshold N to the UAV 201. When the UAV 201 detects N+1 cells, the UAV 201 will select and use the associated BRID resource pool (e.g., resource pool #3). When the UAV 201 files higher, the UVA 201 may have a chance to detect more cells. In some embodiments, the area-based BRID resource pool (e.g., resource pool #3) can be used only when the number of cells fulfilling a configured measurement event detected by the UAV 201 is greater than a given number threshold. For example, the network configures a measurement event A3 and a number threshold N to the UAV 201. When the UAV 201 detects N+1 cells fulfilling A3 event, the UAV 201 will select and use the associated BRID resource pool (e.g., resource pool #3). When the UAV 201 files higher, the UAV 201 may have a chance to detect more cells fulfilling a measurement event. In another word, during a resource pool selection procedure, the UAV 201 determines whether the detected cell number is larger than the configured (or predetermined) threshold and selects the corresponding area-based resource pool. In some embodiments, during resource pool selection procedure, the UAV 201 determines whether the multi-cell measurement report condition is fulfilled and selects the corresponding area-based resource pool.

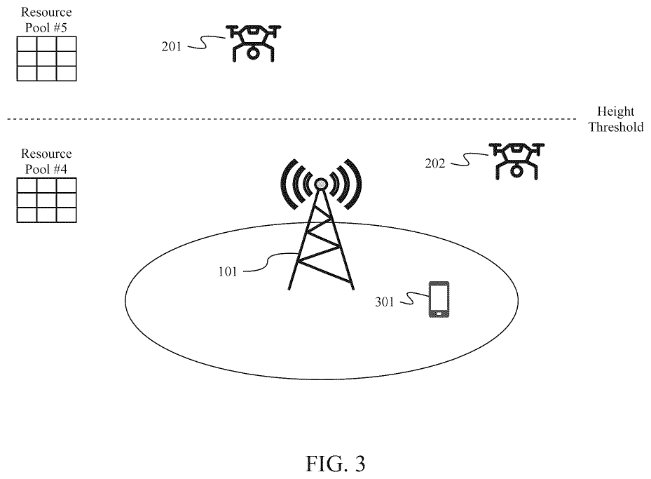

FIG. 3 illustrates a wireless communication system according to some embodiments of the present application. FIG. 3 includes a base station (BS) (or cell) 101, UAVs 201 and 202, and a UE 301.

In an embodiment, the BRID resource pool configuration can be associated with the UAV's height. The mapping relationship between BRID resource pools and height ranges can be configured. For example, BRID resource pool #4 is associated to height range between H1 and H2. H1 and H2 are the height thresholds, for example, in meters. The height may be “the level above ground,” “the level above sea,” “the relative take-off altitude,” the altitude, or a combination thereof. When the UAV is configured with a height-associated BRID resource pool, the UAV uses the corresponding resource pool when the UAV determines its height is in the associated height ranges. Multiple BRID resource pools associated with different height ranges can be configured. In this case, the UAV uses the corresponding BRID resource pool only when the UAV determines its height is in the corresponding height range. In another word, during a resource pool selection procedure, the UAV 201 determines the flying height and selects the resource pool configured associated with the height.

If there has no height based BRID resource pool configured for the height of a UAV, the UAV will use a normal sidelink resource pool for BRID transmissions. For example, in the cast that the network only provides a BRID resource pool configuration for height range larger than 60 meters, if a UAV is flying below 60 meters, the UAV will reuse a normal sidelink resource pool which is configured for terrestrial UEs.

An embodiment may be illustrated in FIG. 3. In FIG. 3, the resource pool #5 is configured to be associated with the height below the height threshold. The height threshold is indicated by the dashed line. The resource pool #5 is configured to be associated with the height above the height threshold. The height of the UAV 201 is above the height threshold, and the UAV 201 is configured to transmit the BRID with the resource pool #5. The UE 301 may receive the BRID of the UAV 201 with the resource pool #5. The height of the UAV 202 is below the height threshold, and the UAV 202 is configured to transmit the BRID with the resource pool #4. The UE 301 may receive the BRID of the UAV 202 with the resource pool #4.

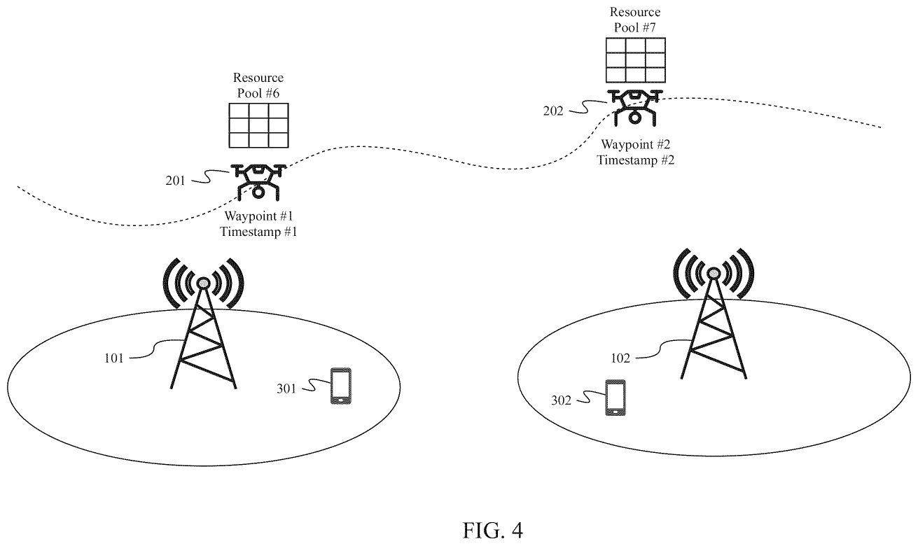

FIG. 4 illustrates a wireless communication system according to some embodiments of the present application. FIG. 4 includes base stations (BS) (or cell) 101 and 102, UAVs 201 and 202, and UEs 301 and 302.

In an embodiment, the BRID resource pool configuration can be associated with flight paths. For example, the mapping relationship between BRID resource pools and waypoints and timestamp in flight paths can be configured. In an embodiment of FIG. 4, the BRID resource pool #6 is associated with the waypoint #1 and the timestamp #1 in the flight path. The flight path is indicated by the dashed line. A UAV 201 uses the corresponding BRID resource pool only when the UAV flies at the associated waypoint, approaches to the waypoint, or flies in the range of waypoint. Further, the condition of using a given BRID resource pool can associated with the time. For example, a UAV uses the corresponding BRID resource pool only when the UAV flies to the associated waypoint at an associated time or within an associated time range. In another word, during a resource pool selection procedure, the UAV 201 determines the location and associated waypoint and/or timestamp in reported flight path and selects the resource pool configured associated with the waypoint and/or timestamp (or time range).

An embodiment may be illustrated in FIG. 4. In FIG. 4, the resource pool #6 is configured to be associated with the waypoint #1 and the timestamp #1. The resource pool #6 may be provided by the BS (or cell) 101. The UAV 201 transmits the BRID with the resource pool #6 when the UAV 201 flies at the waypoint #1, approaches to the waypoint #1, or flies in the range of waypoint #1 at the timestamp #1. The UAV 201 transmits the BRID with the resource pool #6 when the UAV 201 flies at the waypoint #1, approaches to the waypoint #1, or flies in the range of waypoint #1 within a time range indicated by the timestamp #1. The UE 301 may receive the BRID of the UAV 201 with the resource pool #6. When the UAV 201 flies at the waypoint #1, approaches to the waypoint #1, or flies in the range of waypoint #1 at the time other than that indicated by the timestamp #1, the UAV 201 may transmit the BRID with another resource pool (e.g., a normal sidelink resource pool which is configured for terrestrial UEs).

In FIG. 4, the resource pool #7 is configured to be associated with the waypoint #2 and the timestamp #2. The resource pool #7 may be provided by the BS (or cell) 102. The UAV 202 transmits the BRID with the resource pool #7 when the UAV 202 flies at the waypoint #2, approaches to the waypoint #2, or flies in the range of waypoint #2 at the timestamp #2. The UAV 202 transmits the BRID with the resource pool #7 when the UAV 202 flies at the waypoint #2, approaches to the waypoint #2, or flies in the range of waypoint #2 within a time range indicated by the timestamp #2. The UE 302 may receive the BRID of the UAV 202 with the resource pool #7. When the UAV 202 flies at the waypoint #2, approaches to the waypoint #2, or flies in the range of waypoint #2 at the time other than that indicated by the timestamp #2, the UAV 202 may transmit the BRID with another resource pool (e.g., a normal sidelink resource pool which is configured for terrestrial UEs).

In an embodiment of the present application, when a UAV broadcasts the BRID in a RRC CONNECTED mode, the network can configure a dedicated resource pool for the UAV. During a handover between BSs or between cells, whether this dedicated resource pool is reused in the target cell can be explicitly or implicitly indicated in a handover command. Furthermore, the UAV may use the dedicated resource pool, instead of an exceptional resource pool (e.g., a default resource pool), to broadcast the BRID during the handover. In an example of the explicitly way, a 1-bit flag can be used to indicate whether the dedicated resource pool can be still used in the target cell. In an example of the implicitly way, if the handover command does not indicate another resource pool for BRID transmissions, it means the dedicated resource pool configured in the source cell can be still used in the target cell. In the cast that the dedicated configured in the source cell can be used in the target cell, the UAV will not release the configuration and the sensing results associated with the dedicated resource pool, and the UAV will continuously use the dedicated resource pool during and after handover procedures. However, if handover failure happens, the UAV will not use the dedicated resource pool for BRID transmission and will use the exceptional resource pool.

In an embodiment of the present application, if a UAV is in coverage of the carrier or frequency of interest for BRID transmissions, and if the UAV is in an IDLE/INACTIVE mode, the UAV can enter a RRC CONNECTED mode when some one or more conditions happen. The conditions include at least one of:
(1) the network provides at least one frequency for BRID, but does not provide a resource pool configuration;
(2) the network provides at least one frequency for BRID, but does not provide a BRID dedicated resource pool configuration;
(3) the network provides at least one frequency for BRID, but does not provide an area-based BRID dedicated resource pool configuration;
(4) the network provides at least one frequency for BRID, but does not provide SIB specific for BRID;
(5) the network provides at least one frequency for BRID, but does not provide a height-based BRID dedicated resource pool configuration;
(6) the UAV is flying above a height threshold; and
(7) the UAV flight plan contains one or more waypoints above a height threshold.

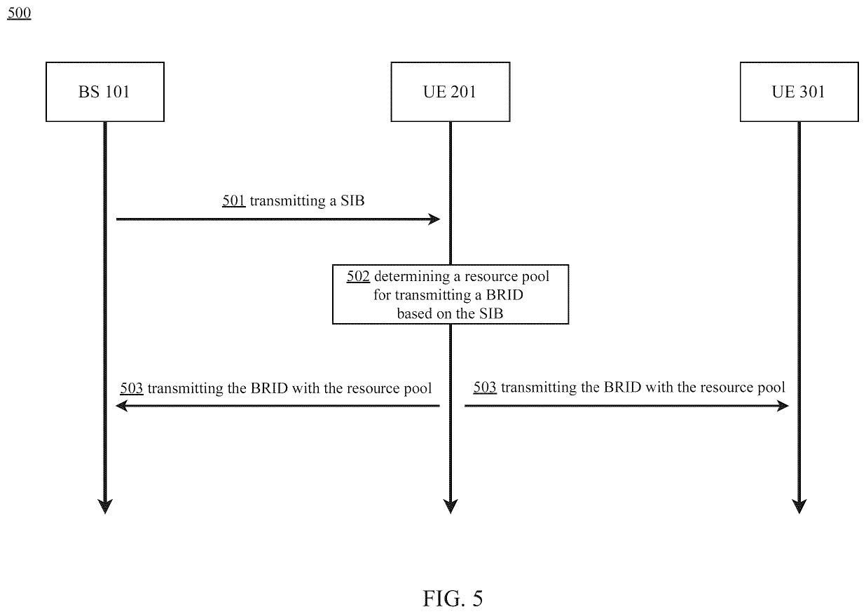

FIG. 5 illustrates a schematic diagram of procedures for transmitting a broadcast remote ID according to some embodiments of the present application. In FIG. 5, a BS (or cell) 101, a UAV 201, and a UE 301 may be involved.

In operation 501, the BS 101 transmits a SIB. The SIB transmitted by the BS 101 may include a SIB for terrestrial sidelink UEs or a SIB for BRID resource pool configuration.

In operation 502, the UAV 201 determines a resource pool for transmitting its own BRID based on the received SIB. The resource pool determined by the UAV 201 may include an area-based resource pool, a height-based resource pool, or a resource pool associated with flight paths.

In operation 503, the UAV 201 transmits the BRID with the resource pool determined in the operation 502. The transmissions in the operation 503 may be a broadcast. The BS 101 may receive the BRID of the UAV 201 with the determined resource pool. The UE 301 may receive the BRID of the UAV 201 with the determined resource pool. In some embodiments, the base station transmitting the SIB and the base station receiving the BRID may not be the same one.

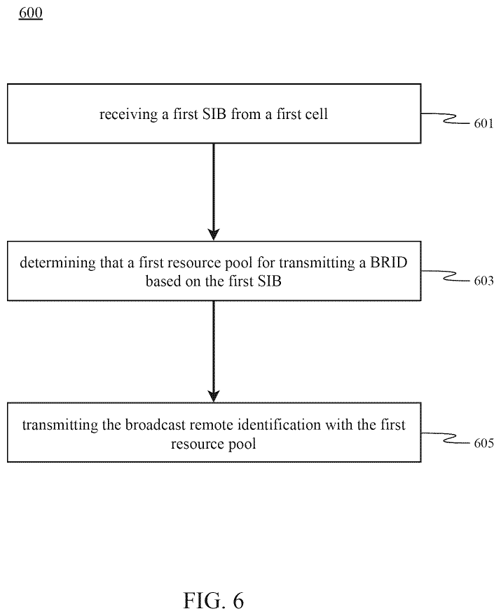

FIG. 6 illustrates a flow chart of a method 600 for transmitting a BRID according to some embodiments of the present application. The method illustrated in FIG. 6 may be performed by a first UE (e.g., the UAV 201 or 202).

The method 600 includes operations 601, 603, and 605. In the operation 601, the first UE receives a first SIB from a first cell or a first BS. In the operation 603, the first UE determines that a first resource pool for transmitting a BRID based on the first SIB. In operation 605, the first UE transmits the BRID with the first resource pool.

In some embodiments, the first resource pool may be associated with a first area. The first area includes coverages of a plurality of BSs or cells.

In some embodiments, the first SIB may include a first ID. The first ID indicates the first area associated with the first resource pool. When the first UE receives a second SIB from a second cell or a second BS, the first UE may transmit the BRID with the first resource pool if the second SIB includes the first ID indicating the first area. When the first UE receives a second SIB from a second cell or a second BS, the first UE may transmit the BRID with a second resource pool if the second SIB includes a second ID indicating a second area associated with the second resource pool, in which the second area is different from the first area.

In some embodiments, the first SIB may be dedicated to the BRID and may be different from a third SIB for sidelink configuration (e.g., for terrestrial UEs).

In some embodiments, the step of transmitting the broadcast remote identification with the first resource pool may comprise: transmitting the BRID with the first resource pool when an elevation of the first UE is greater than an elevation threshold. The first UE may transmit the BRID with a third resource pool for sidelink transmission when the elevation of the first UE is not greater than the elevation threshold.

In some embodiments, the step of transmitting the broadcast remote identification with the first resource pool may comprise: transmitting the BRID with the first resource pool when the number of neighboring cells detected by the first UE is greater than a cell threshold. The first UE may transmit the BRID with a third resource pool for sidelink transmission when the number of neighboring cells detected by the first UE is not greater than the cell threshold.

In some embodiments, the step of transmitting the broadcast remote identification with the first resource pool may comprise: transmitting the broadcast remote identification with the first resource pool when the number of neighboring cells meeting a condition of a measurement event is greater than a cell threshold. The first UE may transmit the BRID with a third resource pool for sidelink transmission when the number of neighboring cells meeting a condition of a measurement event is not greater than a cell threshold.

In some embodiments, at least one resource pool each associated with a height range is configured. The step of determining that a first resource pool for transmitting a BRID may comprise: determining the first resource pool based on height of the first UE. The first UE may transmit the BRID with a third resource pool for sidelink transmission when the height of the first UE does not falls in any height range of the at least one resource pool.

In some embodiments, at least one resource pool each associated with a combination of a waypoint and a timestamp in a flight path of the first UE is configured. The step of determining that a first resource pool for transmitting a BRID may comprise: selecting the first resource pool from the at least one resource pool based on a current waypoint of the first UE and a current timestamp of the first UE.

In some embodiments, when the first UE is in a connected mode and during a handover, the first US determines whether the first resource pool is used to transmit the broadcast remote identification in a target cell based on a received handover command.

In some embodiments, when the first UE is in an idle or inactive mode, entering a connected mode based on at least one of the following:
(1) a frequency for broadcast remote identification is provided by a network without a resource pool configuration;
(2) a frequency for broadcast remote identification is provided by the network without a resource pool configuration dedicated to transmitting the broadcast remote identification;
(3) a frequency for broadcast remote identification is provided by the network without an area-based resource pool configuration dedicated to transmitting the broadcast remote identification;
(4) a frequency for broadcast remote identification is provided by the network without a SIB dedicated to broadcast remote identification;
(5) a frequency for broadcast remote identification is provided by the network without a height-based resource pool configuration dedicated to transmitting the broadcast remote identification;
(6) an elevation of the first UE is greater than an elevation threshold; or
(7) a flight plan of the first UE includes a waypoint above the elevation threshold.

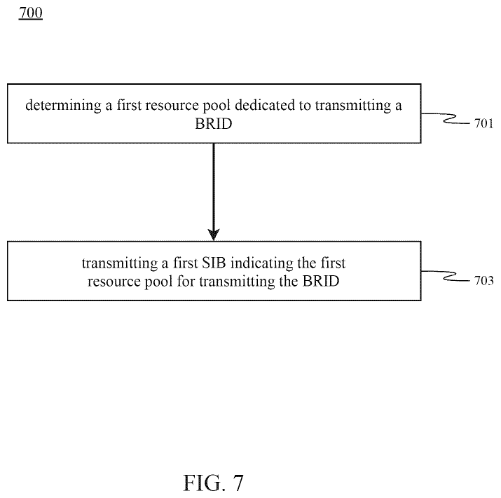

FIG. 7 illustrates a flow chart of a method 700 for a BRID according to some embodiments of the present application. The method illustrated in FIG. 7 may be performed by a first BS (or a first cell) (e.g., one of the BSs 101 to 104).

The method 700 includes operations 701 and 703. In the operation 701, the first BS determines a first resource pool dedicated to transmitting a broadcast remote identification. In the operation 703, the first BS transmits a first system information block (SIB) indicating the first resource pool for transmitting the BRID.

In some embodiments, the first resource pool may be associated with a first area including coverages of a plurality of BSs or cells.

In some embodiments, the first SIB may include a first ID indicating the first area associated with the first resource pool.

In some embodiments, the first SIB may be dedicated to the BRID and may be different from a second SIB for sidelink configuration (e.g., for terrestrial UEs).

In some embodiments, the first BS may further determines at least one resource pool each associated with a height range, and the first resource pool is included in the at least one resource pool.

In some embodiments, the first BS may further determines at least one resource pool for a UE each associated with a combination of a waypoint and a timestamp in a flight path of the UE, and the first resource pool is included in the at least one resource pool.

In some embodiments, the first BS may further determine whether the first resource pool is applicable for a UE during and after handover. The first BS may further transmits, to the UE, a flag indicating whether the first resource pool is applicable for the UE during and after the handover.

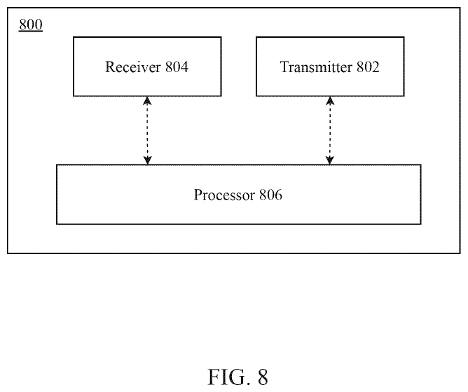

FIG. 8 illustrates a simplified block diagram of an exemplary apparatus 800 according to some embodiments of the present application. The apparatus 800 may be a first UE (e.g., the UAV 201 or 202) or a first BS (e.g., one of the BSs 101 to 104).

Referring to FIG. 8, the apparatus 800 may include at least one transmitter 802, at least one receiver 804, and at least one processor 806. The at least one transmitter 802 is coupled to the at least one processor 806, and the at least one receiver 804 is coupled to the at least one processor 806. The at least one transmitter 802 may be coupled with the at least one receiver 804.

Although in this figure, elements such as the transmitter 802, the receiver 804, and the processor 806 are illustrated in the singular, the plural is contemplated unless a limitation to the singular is explicitly stated. In some embodiments of the present application, the transmitter 802 and the receiver 804 may be combined to one device, such as a transceiver. In some embodiments of the present application, the apparatus 800 may further include an input device, a memory, and/or other components. The transmitter 802, the receiver 804, and the processor 806 may be configured to perform any of the methods described herein (e.g., the method described with respect to any of FIGS. 6 and 7).

According to some embodiments of the present application, the apparatus 800 may be a first UE. In some embodiments of the present application, the receiver 804 is configured to receive a first SIB from a first cell or a first BS. The processor 806 is configured to determine that a first resource pool for transmitting a BRID based on the first SIB. The transmitter 802 is configured to transmit the BRID with the first resource pool.

In some embodiments of the present application, the first resource pool may be associated with a first area. The first area includes coverages of a plurality of BSs or cells.

In some embodiments of the present application, the first SIB may include a first ID. The first ID indicates the first area associated with the first resource pool. When the first UE receives a second SIB from a second cell or a second BS, the transmitter 802 may transmit the BRID with the first resource pool if the second SIB includes the first ID indicating the first area. When the first UE receives a second SIB from a second cell or a second BS, the transmitter 802 may transmit the BRID with a second resource pool if the second SIB includes a second ID indicating a second area associated with the second resource pool, in which the second area is different from the first area.

In some embodiments of the present application, the first SIB may be dedicated to the BRID and may be different from a third SIB for sidelink configuration (e.g., for terrestrial UEs).

In some embodiments of the present application, the transmitter 802 is configured to transmit the BRID with the first resource pool when an elevation of the first UE is greater than an elevation threshold. The transmitter 802 is further configured to transmit the BRID with a third resource pool for sidelink transmission when the elevation of the first UE is not greater than the elevation threshold.

In some embodiments of the present application, the transmitter 802 is configured to transmit the BRID with the first resource pool when the number of neighboring cells detected by the first UE is greater than a cell threshold. The transmitter 802 is further configured to transmit the BRID with a third resource pool for sidelink transmission when the number of neighboring cells detected by the first UE is not greater than the cell threshold.

In some embodiments of the present application, the transmitter 802 is configured to transmit the BRID with the first resource pool when the number of neighboring cells meeting a condition of a measurement event is greater than a cell threshold. The transmitter 802 is further configured to transmit the BRID with a third resource pool for sidelink transmission when the number of neighboring cells meeting a condition of a measurement event is not greater than a cell threshold.

In some embodiments of the present application, at least one resource pool each associated with a height range is configured. The processor 806 determines the first resource pool based on a height of the first UE. The transmitter 802 is further configured to transmit the broadcast remote identification with a third resource pool for sidelink transmission when the height of the first UE does not falls in any height range of the at least one resource pool.

In some embodiments of the present application, at least one resource pool each associated with a combination of a waypoint and a timestamp in a flight path of the first UE is configured. The first resource pool is selected from the at least one resource pool based on a current waypoint of the first UE and a current timestamp of the first UE.

In some embodiments of the present application, when the first UE is in a connected mode and during a handover, the processor 806 is further configured to determine whether the first resource pool is used to transmit the broadcast remote identification in a target cell based on a received handover command.

In some embodiments of the present application, when the first UE is in an idle or inactive mode, the first UE is further enter a connected mode based on at least one of the following:
(1) a frequency for broadcast remote identification is provided by a network without a resource pool configuration;
(2) a frequency for broadcast remote identification is provided by the network without a resource pool configuration dedicated to transmitting the broadcast remote identification;
(3) a frequency for broadcast remote identification is provided by the network without an area-based resource pool configuration dedicated to transmitting the broadcast remote identification;
(4) a frequency for broadcast remote identification is provided by the network without a SIB dedicated to broadcast remote identification;
(5) a frequency for broadcast remote identification is provided by the network without a height-based resource pool configuration dedicated to transmitting the broadcast remote identification;
(6) an elevation of the first UE is greater than an elevation threshold; or
(7) a flight plan of the first UE includes a waypoint above the elevation threshold.

According to some embodiments of the present application, the apparatus 800 may be a first BS (or a first cell). In some embodiments of the present application, the transmitter 802 is configured to transmit a first system information block (SIB). The first SIB indicates a first resource pool for transmitting a broadcast remote identification.

In some embodiments of the present application, the first resource pool may be associated with a first area. The first area includes coverages of a plurality of BSs or cells.

In some embodiments of the present application, the first SIB may include a first ID indicating the first area associated with the first resource pool.

In some embodiments of the present application, the first SIB may be dedicated to the BRID and may be different from a second SIB for sidelink configuration (e.g., for terrestrial UEs).

In some embodiments of the present application, the processor 806 is further configured to determine at least one resource pool each associated with a height range. The first resource pool is included in the at least one resource pool.

In some embodiments of the present application, the processor 806 is further configured to determine at least one resource pool for a UE each associated with a combination of a waypoint and a timestamp in a flight path of the UE, and the first resource pool is included in the at least one resource pool.

In some embodiments of the present application, the processor 806 is further configured to determine whether a first resource pool is applicable for a UE during and after handover. The transmitter 802 is further configured to transmit a flag indicating whether the first resource pool is applicable for the UE during and after the handover.

In some embodiments of the present application, the apparatus 800 may further include at least one non-transitory computer-readable medium. In some embodiments of the present disclosure, the non-transitory computer-readable medium may have stored thereon computer-executable instructions to cause the processor 806 to implement any of the methods as described above. For example, the computer-executable instructions, when executed, may cause the processor 806 to interact with the transmitter 802 and/or the receiver 804, so as to perform operations of the methods, e.g., as described with respect to FIGS. 6 and 7.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for BRID transmissions, including a processor and a memory. Computer programmable instructions for implementing a method for BRID transmissions are stored in the memory, and the processor is configured to perform the computer programmable instructions to implement the method for BRID transmissions. The method for BRID transmissions may be any method as described in the present application.

Persons skilled in the art should understand that as the technology develops and advances, the terminologies described in the present application may change, and should not affect or limit the principle and spirit of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for SL positioning according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A first user equipment (UE) for wireless communication, comprising:
at least one memory; and
at least one processor coupled with the at least one memory and configured to cause the first UE to:
receive a first system information block (SIB) from a first cell;
determine a first resource pool for transmitting a broadcast remote identification based on the first SIB; and
transmit the broadcast remote identification with the first resource pool.

2. The first UE of claim 1, wherein the first resource pool is associated with a first area including coverages of a plurality of base stations (BS) or a plurality of cells.

3. The first UE of claim 2, wherein the first SIB includes a first ID indicating the first area associated with the first resource pool, and wherein, when the UE receives a second SIB from a second cell, the at least one processor is further configured to cause the first UE to:
transmit the broadcast remote identification with the first resource pool if the second SIB includes the first ID indicating the first area; and
transmit the broadcast remote identification with a second resource pool if the second SIB includes a second ID indicating a second area associated with the second resource pool, where the second area is different from the first area.

4. The first UE of claim 2, wherein:
the first SIB is dedicated to the broadcast remote identification and different from a third SIB for sidelink configuration.

5. The first UE of claim 2, wherein the at least one processor is further configured to cause the first UE to: transmit the broadcast remote identification with the first resource pool when an elevation of the first UE is greater than an elevation threshold; and
transmit the broadcast remote identification with a third resource pool for sidelink transmission when the elevation of the first UE is not greater than the elevation threshold.

6. The first UE of claim 2, wherein the at least one processor is further configured to cause the first UE to: transmit the broadcast remote identification with the first resource pool when the number of neighboring cells detected by the first UE is greater than a cell threshold; and
transmit the broadcast remote identification with a third resource pool for sidelink transmission when the number of neighboring cells detected by the first UE is not greater than the cell threshold.

7. The first UE of claim 2, wherein the at least one processor is further configured to cause the first UE to: transmit the broadcast remote identification with the first resource pool when the number of neighboring cells meeting a condition of a measurement event is greater than a cell threshold; and
the broadcast remote identification with a third resource pool for sidelink transmission when the number of neighboring cells meeting a condition of a measurement event is not greater than a cell threshold.

8. The first UE of claim 1, wherein, when at least one resource pool each associated with a height range is configured, the at least one processor is further configured to cause the first UE to determine the first resource pool based on a height of the first UE; and
to transmit the broadcast remote identification with a third resource pool for sidelink transmission when the height of the first UE is not in any height range of the at least one resource pool.

9. The first UE of claim 1, wherein, when at least one resource pool each associated with a combination of a waypoint and a timestamp in a flight path of the first UE is configured, the first resource pool is selected from the at least one resource pool based on a current waypoint of the first UE and a current timestamp of the first UE.

10. The first UE of claim 1, wherein, when the first UE is in a connected mode and during a handover,
the at least one processor is further configured to cause the first UE to: determine whether the first resource pool is used to transmit the broadcast remote identification in a target cell based on a received handover command.

11. The first UE of claim 1, wherein, when the first UE is in an idle or inactive mode, the at least one processor is further configured to cause the first UE to: enter a connected mode based on at least one of the following:
a frequency for broadcast remote identification is provided by a network without a resource pool configuration;
a frequency for broadcast remote identification is provided by the network without a resource pool configuration dedicated to transmitting the broadcast remote identification;
a frequency for broadcast remote identification is provided by the network without an area-based resource pool configuration dedicated to transmitting the broadcast remote identification;
a frequency for broadcast remote identification is provided by the network without a SIB dedicated to broadcast remote identification;
a frequency for broadcast remote identification is provided by the network without a height-based resource pool configuration dedicated to transmitting the broadcast remote identification;
an elevation of the first UE is greater than an elevation threshold; or
a flight plan of the first UE includes a waypoint above the elevation threshold.

12. A first base station (BS) for wireless communication, comprising:
at least one memory;
at least one processor coupled with the at least one memory and configured to cause the first BS to:
transmit a first system information block (SIB), wherein the first SIB indicates a first resource pool for transmitting a broadcast remote identification.

13. The first BS of claim 12, wherein the first resource pool is associated with a first area including coverages of a plurality of base stations (BS) or a plurality of cells.

14. The first BS of claim 12, wherein the at least one processor is further configured to cause the first BS to: determine at least one resource pool each associated with a height range, and the first resource pool is included in the at least one resource pool.

15. The first BS of claim 12, wherein the at least one processor is further configured to cause the first BS to:
determine whether a first resource pool is applicable for a UE during and after handover, and
transmit a flag indicating whether the first resource pool is applicable for the UE during and after the handover.

16. A processor for wireless communication, comprising:
at least one controller coupled with at least one memory and configured to cause the processor to:
receive a first system information block (SIB) from a first cell;
determine a first resource pool for transmitting a broadcast remote identification based on the first SIB; and
transmit the broadcast remote identification with the first resource pool.

17. The processor of claim 16, wherein the first resource pool is associated with a first area including coverages of a plurality of base stations (BS) or a plurality of cells.

18. The processor of claim 16, wherein, when at least one resource pool each associated with a height range is configured, the at least one controller is further configured to cause the processor to determine the first resource pool based on a height of the processor; and
transmit the broadcast remote identification with a third resource pool for sidelink transmission when the height of the processor is not in any height range of the at least one resource pool.

19. The processor of claim 16, wherein, when at least one resource pool each associated with a combination of a waypoint and a timestamp in a flight path of the processor is configured, the first resource pool is selected from the at least one resource pool based on a current waypoint of the processor and a current timestamp of the processor.

20. A method performed by a user equipment (UE), the method comprising:
receiving a first system information block (SIB) from a first cell;
determining a first resource pool for transmitting a broadcast remote identification based on the first SIB; and
transmitting the broadcast remote identification with the first resource pool.
